(19) United States
(12) Patent Application Publication
(10) Pub. No.: US 2022/0163796 A1
(43) Pub. Date: May 26, 2022

(54) Wearable Display Device and Visual Access Operating System Thereof

(71) Applicant: Ostendo Technologies, Inc., Carlsbad, CA (US)

(72) Inventor: Hussein S. El-Ghoroury, Carlsbad, CA (US)

(21) Appl. No.: 17/531,625

(22) Filed: Nov. 19, 2021

Related U.S. Application Data
(60) Provisional application No. 63/118,494, filed on Nov. 25, 2020.

(51) Int. Cl. G02B 27/00; G02B 27/01

(52) U.S. Cl. CPC G02B 27/0093; G02B 27/0101; G02B 27/0179; G02B 2027/0178; G02B 2027/0123; G02B 2027/0187; G02B 27/0172

(57) ABSTRACT

A wearable display device includes a visual access operating system (vuOS) that can interface with multiple computing platforms. The vuOS enables concurrent visual interface between the multiple computing platforms and a user and performs context switching between the multiple computing platforms in response to either a computing platform visual access request or a user's selection prompt. The multiple computing platforms are each assigned a user selected visual access slot that occupies a selected segment of the user field of view (FOV) visually accessible by the wearable display system. At any given time one of the multiple computing platforms visual access slots is brought onto the user's gaze zone in the FOV while some of the other computing platforms visual access slots are assigned to the peripheral vision zone and other computing platforms are assigned visual access attention request access slots displayed at a visual attention zone within the user's viewable portion of the wearable display FOV. The wearable display vuOS further allocates to each of the multiple computing platforms a physical interface connection having an interface throughput that is commensurate with their assigned visual slot size and position within the user field of view (FOV) visually accessible by the wearable display system.

### CROSS REFERENCE TO RELATED DOCUMENTS

This non-provisional U.S. utility patent application is related to, and claims priority to, provisional patent application No. 63/118,494 filed Nov. 25, 2020, entitled “Wearable Display and Visual Access Operating System Thereof”, the contents of which are incorporated herein by reference in their entirety.

### FIELD OF THE INVENTION

Embodiments of the invention relate to wearable display devices comprising a visual access operating system (vuOS) that can be used to manage and allocate visual access to the wearable display device amongst multiple computing platforms.

### BACKGROUND

Wearable display devices, also known as wearable displays, or head mounted displays, are poised to become the next widely used visual interface device in the chain of the computing evolution from the personal—to the portable—to the mobile-computing platforms. This is the case because the visual interface to computing platforms is increasingly becoming the primary bottleneck standing in the way of continuing growth of mobile digital media. In today's world users are typically mobile and need continuous access to the multiple computing platforms they encounter in their daily activities from their smartphone to the computers (PCs) at their office to their car computers and the multiple computing platforms they use at home such as the PC, Tablets, laptops, streaming video boxes, set top boxes and game boxes. The wearable display is emerging to become the visual interface device that will not only expand the users' visual interface throughput by being immersive and volumetrically acceptable but also to enable continuous uninterrupted and seamless access to, across, or between, the multiple computing platforms users encounter in their daily activities. This disclosure describes wearable display system level details, specifically the visual access operating system (vuOS) that enables the emerging wearable display devices to fulfill that destiny.

The term “Wearable Display” herein is meant to refer to a head mounted display (HMD) having the weight and volumetric displacement of a typical acceptable style of sunglasses without infringing on the personal appearance of its user negatively impacting the social acceptance of the wearable display by the user or others, or causing any physical fatigue or discomfort to its user even after prolonged use, while enabling maximal mobile access to information (Visual, Audio and Interactive information).

Additional objectives and advantages of embodiments of the invention will become apparent from the following detailed description of embodiments thereof that proceeds with reference to the accompanying drawings.

### BRIEF DESCRIPTION OF THE DRAWINGS

The invention is illustrated by way of example, and not by way of limitation, in the figures of the accompanying drawings in which like reference numerals refer to similar elements.

FIG. 1A illustrates an exemplary wearable display device 100 that comprises the visual access operating system according to embodiments of the invention.

FIG. 1B illustrates an expanded view of the exemplary wearable display device 100 that comprises the visual access operating system according to embodiments of the invention.

FIG. 1C illustrates a high level functional block diagram of components or elements of the exemplary wearable display device 100, comprising the visual access operating system according to embodiments of the invention.

FIG. 2 illustrates a visual context switching operational concept of the exemplary wearable display device 100 according to embodiments of the invention.

FIG. 3 illustrates a high level functional block diagram of the exemplary wearable display device 100's visual access operating system according to embodiments of the invention.

FIG. 4 illustrates the viewable display zones of the wearable display device that are managed and allocated by the visual access operating system of according to embodiments the invention amongst multiple computing platforms interfacing with the wearable display device.

FIG. 5 illustrates the wearable display device physical interfaces that are managed and allocated by the visual access operating system according to embodiments of the invention amongst the multiple computing platforms interfacing with the wearable display device.

### DETAILED DESCRIPTION OF THE INVENTION

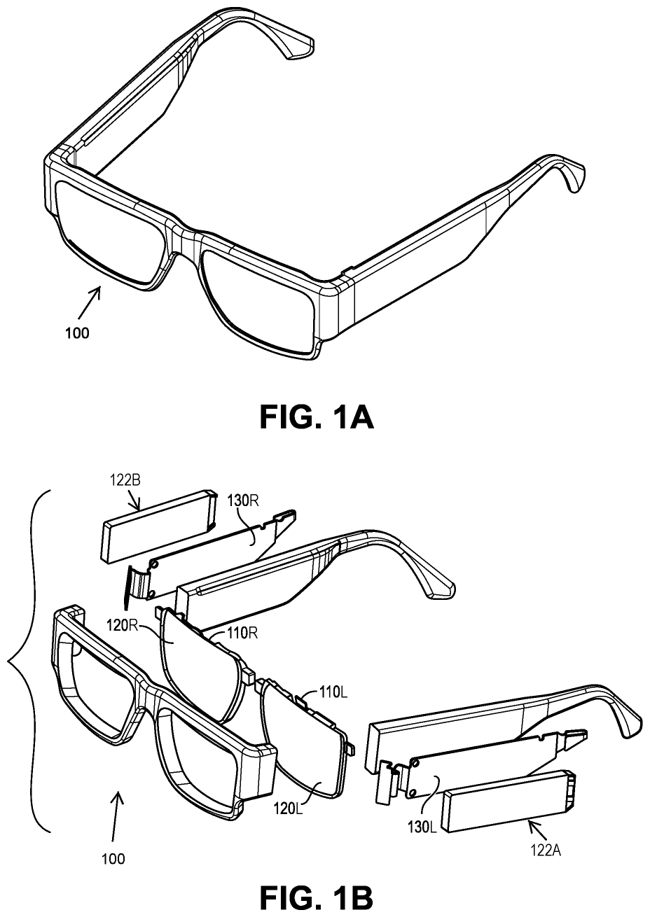

FIG. 1A illustrates an example of a wearable display device 100, such as a pair of wearable display glasses. The wearable display device 100, or simply, wearable display 100, includes a visual access operating system (vuOS) according to embodiments of the invention. The wearable display device 100 is lightweight and small, in terms of volumetric displacement, which makes the device readily wearable by users as conventional sunglasses. The lightweight and small volumetric displacement aspects of the wearable display device are paramount because these aspects enable the users to wear the device for extended periods of time.

In the exemplary wearable display device, achieving wearablity is accomplished by using a micro-LED based light modulation device as the display element 110. A non-limiting example of such a device is a CMOS/III-V integrated 3D micro-LED array emissive device referred to as a “Quantum Photonic Imager2” display or “QPI®” display. QPI® is a registered trademark of Ostendo Technologies, Inc., Applicant of the instant application. This new class of emissive micro-scale pixel (i.e., micropixel) array imager device is disclosed in, for instance, U.S. Pat. Nos. 7,623,560, 7,767,479, 7,829,902, 8,049,231, 8,243,770, 8,567,960, and 8,098,265, the contents of each of which is fully incorporated herein by reference. The disclosed QPI display devices desirably feature high brightness, very fast multi-color light intensity and spatial modulation capabilities all in a very small device size that includes all required image processing control circuitry. The solid state light-(SSL) emitting pixels of these disclosed devices may be either a light emitting diode (LED) or laser diode (LD), or both, whose on-off state is controlled by control circuitry contained within a CMOS controller chip (or device) upon which the emissive micro-scale pixel array of the QPI display imager is bonded and electronically coupled. The size of the pixels comprising the QPI displays may be in the range of approximately 5-20 microns with a typical chip-level emissive surface area being in the range of approximately 15-150 square millimeters. The pixels of the above emissive micro-scale pixel array display devices are individually addressable spatially, chromatically and temporally through the drive circuitry of its CMOS controller chip. The brightness of the light generated by such imager devices can reach multiple 100,000s cd/m2 at reasonably low power consumption. The micro-LED based light modulation device integrates the optical coupling as well as the needed display graphics processing of the wearable display in a volumetrically efficient single semiconductor device or chip that can also be efficiently integrated volumetrically onto the edge of the wearable display relay and magnification optics or lenses as illustrated in FIG. 1A, thereby expanding the view box.

FIG. 1B illustrates an expanded view of an exemplary wearable display device 100 that comprises the visual access operating system (vuOS) according to embodiments of the invention. As illustrated in FIG. 1B, the exemplary wearable display device 100 incorporates two display elements 110L and 110R respectively positioned on the side, or edge, for example, the top side, or top edge, of, and optically coupled to, the left and right optical lenses 120L and 120R and associated electronic circuit boards 122A and 122B encapsulated within the wearable display glasses side arms 130L and 130R.

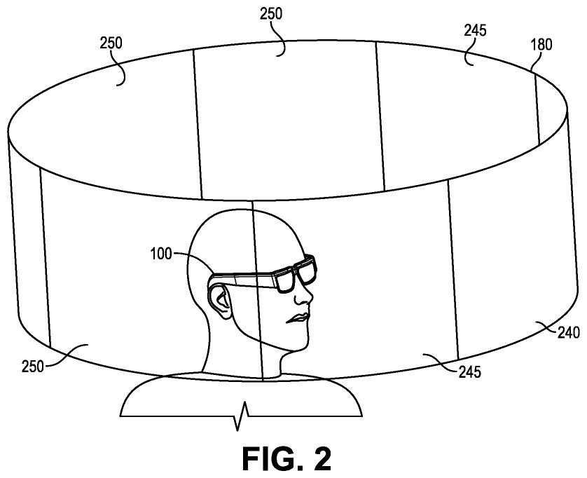

FIG. 1C is a high level functional block diagram that illustrates components or elements of the exemplary wearable display device 100 and associated interfaces according to embodiments of the invention. With reference to FIG. 1C, electronic circuit boards 122A and 122B incorporate a number of semiconductor devices including a graphics processing unit (GPU) 150, a communications or connectivity interface processor (CIP) 160, and one or more sensors 132 that collectively detect the exemplary wearable display device 100 user's head and/or eye position and orientation. The CIP 160 includes the connectivity assets of the exemplary wearable display device 100 and includes software and hardware components or elements that enable wired or wireless connectivity interfaces 170 (shown in FIG. 3) of the exemplary wearable display device 100 to connect to external computing platforms that the user of the exemplary wearable display device 100 encounters in typical daily activities, such as a Smartphone, PC, Tablet, laptop, or vehicle (e.g., car, motorcycle, scooter, electric bicycle, bicycle) computing platform and/or multimedia system, streaming video box, cable set top box or game box, etc. These external computing platforms, in some examples, can also have one or more input devices, such as a keyboard, a mouse, a trackpad, a light pen, a biometric input device, a voice input device, etc. Input can be received by these input devices and transmitted by CIP 160 to wearable display device 100 for further processing by wearable display device 100 as discussed herein below. These devices are well known in the art and need not be discussed at length here.

As shown in FIG. 1C, the GPU 150 interfaces with the display elements 110L and 110R at the left and right sides of wearable display device 100, while the CIP 160 is functionally (electrically) coupled to the GPU 150 to provide connectivity with external computing platforms either through wire or wireless interfaces. FIG. 1C also illustrates the optical coupling between the display elements 110L and 110R and respective optical elements (i.e., optical lenses) 120L and 120R at the left and right sides of wearable display device 100. Together, the left and right display elements 110L and 110R and the left and right optical elements 120L and 120R define the visual access assets or resources of the exemplary wearable display device 100. In particular, the optical elements 120L and 120R define the geometric extent of the user's visual access Field of View (FOV) 180 of the exemplary wearable display device 100.

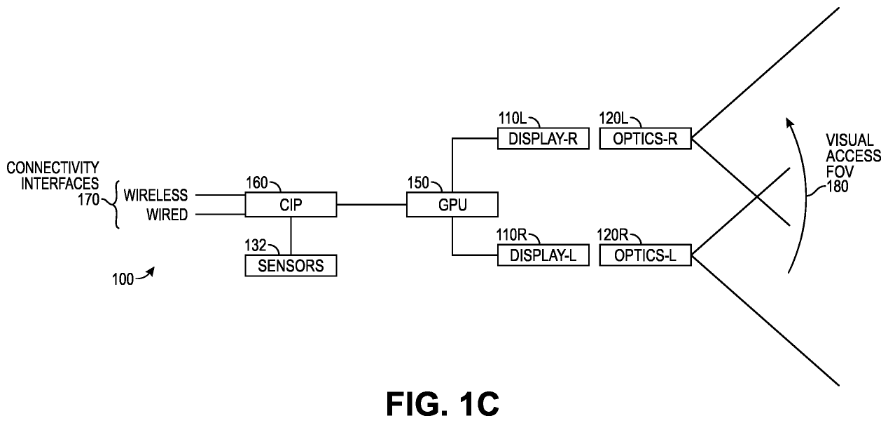

FIG. 2 illustrates the visual access Field of View (FOV) 180 used within the operational context of the exemplary wearable display device 100 according to embodiments of the invention. As can be seen, the FOV is divided into visual access segments, or zones, or slots, such as central zone 240 in the center of the user's view, and one or more peripheral zones 245 to the left and/or right of the central zone 240. One or more zones 250 are currently outside the FOV 180, as denoted by the dashed lines. As illustrated in FIG. 2 the objective of methods described herein is to enable the user (or viewer) of the exemplary wearable display device 100 to visually interface with multiple computing platforms the user typically encounters in daily activities.

Another objective of methods described herein is to enable the exemplary wearable display device 100 to allocate the visual access assets or resources (i.e., the left and right display elements 110L and 110R and the left and right optical elements 120L and 120R) of the exemplary wearable display device 100 in response the user's visual access prompts for visual interface to one or more of the computing platforms interfacing with the exemplary wearable display device 100.

Another objective of methods described herein is to enable the exemplary wearable display device 100 to allocate the visual access assets or resources of the exemplary wearable display device 100 in response to visual access requests from one or more of the computing platforms interfacing with the exemplary wearable display device 100.

Another objective of methods described herein is to enable the exemplary wearable display device 100 to allocate the visual access assets or resources of the exemplary wearable display device 100 in response to a user's visual access prompts and/or visual access requests from the computing platforms interfacing with the exemplary wearable display device 100.

The methods described herein are collectively aimed at enabling the user of the exemplary wearable display device 100 to gain visual access to one or more of the computing platforms by allocating the appropriately needed internal computing, memory and interface resources of the exemplary wearable display device 100 to service and match the data connectivity throughput of the interfacing computing platforms with the visual throughput of the allocated visual assets of exemplary wearable display device 100.

While the above objectives are describe below with reference to one or more computing platforms, it is appreciated, according to alternative embodiments of the invention, the above objectives may be applied to not just different computing platforms, but to different application programs executing on the same or different computing platforms including application programs executing on cloud-based computing platforms, or to different windows or displays for the same application program executing on a single computing platform.

As illustrated in FIG. 2, the objective of enabling the user of the exemplary wearable display device 100 to visually interface with the multiple computing platforms the user typically encounters in daily activities is accomplished by assigning each one of the computing platforms interfacing with the exemplary wearable display device 100 to, or associating each computing platform with, an appropriate visual access segment or zone or slot of the exemplary wearable display device 100 visual access FOV 180. For example, as illustrated in FIG. 2, a central visual access zone 240 of the visual access FOV 180, also referred to herein as a gaze zone 240, or a visual access slot 240, is allocated to service the visual interface with the user's Smartphone, for example, while so-called peripheral visual zones 245 to the left and right of the gaze zone 240, also referred to herein as extended gaze zones 245, or visual access slots 245, are allocated to service other connected computing platforms such as a PC and a game box, for example.

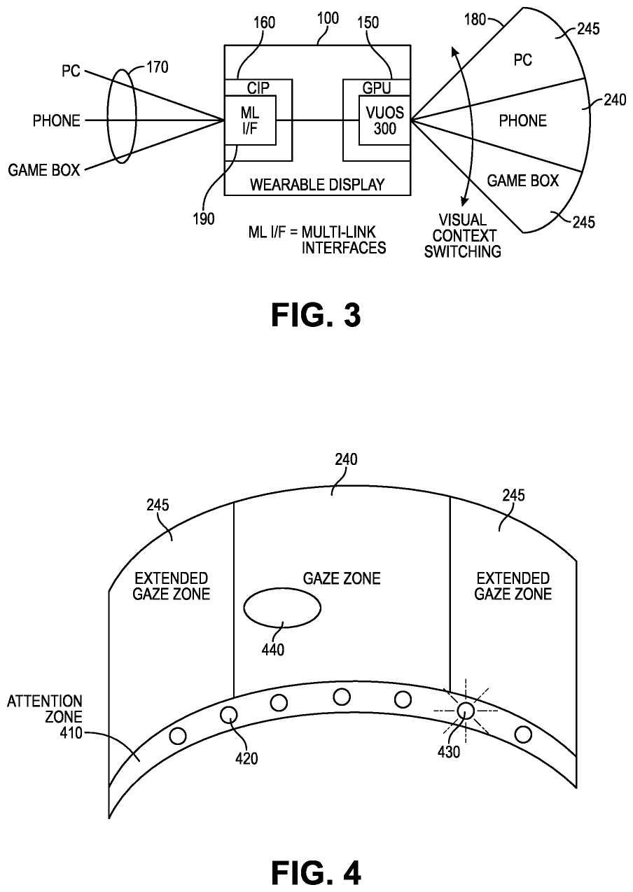

The user's visual access transition, herein referred to as visual context switching, is meant to indicate the assignment of the gaze zone 240 of the visual access FOV 180 to one of the computing platforms actively connected to (or interfacing with) the exemplary wearable display device 100. The visual context switching between the computing platforms actively connected to (or interfacing with) the exemplary wearable display device 100 may occur in response to the wearable display device 100 user's prompts as indicated by input or command received from, for example, the user's head movement, hand gesture, finger gesture, voice or visual commands. A visual command, according to one embodiment, is detected when the user focuses on a specific displayed object, for example an attention request icon 420, or an illuminated attention icon 430, as illustrated in FIG. 4. The icon position within the displayed content is known to the visual operating system 300 and matched with the user visual convergence (accommodation) position within the wearable display device 100 visual access FOV 180 as detected by the eye movement sensors 132.

Regarding visual commands, by correlating the sensed eye convergence position with an icon position, whether the attention request icon 420 or the illuminated attention icon 430 in the above examples, within the wearable display device 100 visual access FOV 108, the visual access operating system (vuOS) responds by allocating a pre-specified interpretation of the icon either to (1) visual access slots 240 or 245, or (2) augmented visual access slot 440 as depicted in FIG. 4. As explained herein below, the augmented visual access slot 440 can be assigned by the connected computing platform OS to an application program running on that platform.

According to scenario (1), if, for example, a text message is received by a smart phone connected to the wearable display device 100, the phone's operating system or an application on the phone signals a request to the wearable display device for an augmented visual access slot 440 allocation by first sending a command to illuminate its assigned attention request icon 420. The vuOS then responds by illuminating the associated illuminated attention icon 430 and when the user responds by focusing on the illuminated attention icon 430, the vuOS then allocates an augmented visual access slot 440 and overlays the text message content received from the phone within the augmented visual access slot 440. Note that any of the connected computing platforms can do that whether or not they have an on-going association with visual access slot 240 or 245 allocation.

According to scenario (2), a first connected computing platform has a pre-specified need to preempt the on-going gaze zone 240 assignment from a second connected computing platform to the first computing platform, for example. The first computing platform OS signals that preemption request to the wearable display device by first sending a command to illuminate its assigned attention request icon 420. When the user responds to the icon, for example, by focusing on the illuminated attention icon 430, the vuOS preempts the on-going gaze zone 240 allocation from the second connected computing platform and then allocates the visual access slot for gaze zone 240 to the signaling first connected computing platform. To make visual commands easier for the user, according to one embodiment, the wearable display device may insert a cursor augmentation within the visual access zones 240, 245 or 410 that is controlled by the user's eye convergence position as sensed by the wearable display device. The user is then in visual control of the augmented cursor position and able to visually place it anywhere within the visual access zones 240, 245 and 410, for example to respond to an illuminated attention icon 430.

A user's head movement, for example, as detected by sensors 132, indicates the user's gaze zone 240 being assigned by the user to one of a number of computing platforms actively connected to (or interfacing with) the exemplary wearable display device 100, according to embodiments of the invention.

A user's hand gesture can also, or alternatively, indicate the user's gaze zone 240 being assigned by the user to one of the number of computing platforms actively connected to (or interfacing with) the exemplary wearable display device 100, as indicated by the user's hand configuration, and/or position, and/or movement detected by sensors 132, according to some embodiments.

A user's voice command can also, or alternatively, indicate the user's gaze zone 240 being assigned by the user to one of the number of computing platforms actively connected to (or interfacing with) the exemplary wearable display device 100 as indicated by the user's voice command.

A visual command can also, or alternatively, indicate the user's gaze zone 240 being assigned by the user to one of the number of computing platforms actively connected to (or interfacing with) the exemplary wearable display device 100 as indicated by the detected user's eye movement or eye focus direction.

Finally, input from one or more input devices associated with any one of the external computing platforms, such as a keyboard, a mouse, a trackpad, a light pen, a biometric input device, a voice input device, etc., can be received over an appropriate connectivity interface 170 by wearable display device 100 to indicate the user's gaze zone 240 being assigned by the user to the same or another one of the external computing platforms actively connected to (or interfacing with) the exemplary wearable display device 100.

As illustrated in FIG. 2, visual access to a number of the computing platforms actively connected to (or interfacing with) the exemplary wearable display device 100 may be allocated or mapped to the gaze zone 240, and one or more peripheral visual access regions, or peripheral visual access zones 245, herein referred to as the extended gaze zones 245 which together with the gaze zone 240 comprise the wearable display device visual access FOV 180. The computing platforms assigned visual access to zones within the wearable display device visual access FOV 180 are actively connected to wearable display device 100 and are said to be online or in an active mode. The computing platforms assigned visual access to zones outside the wearable display device visual access FOV 180, e.g., allocated to one or more of zones 250, may be actively connected to wearable display device, or not, and are said to be in standby or inactive mode and transition the active mode when granted visual access to zone within the wearable display device visual access FOV 180. Similarly, the computing platforms assigned visual access to zones within the wearable display device visual access FOV 180, e.g., allocated to one or more of zones 240 and 245, may be actively connected to wearable display device and are said to be in active mode and transition the standby, or inactive mode when switched to visual access to a zone outside the wearable display device visual access FOV 180, e.g., zone 250.

The capability of visual context switching between the computing platforms actively connected to (or interfacing with) the exemplary wearable display device 100 is made possible by a visual access Operating System, herein referred to as vuOS, that operates as a software module or component or element that executes on the GPU 150 with control domain that extends across the computing, memory, and interface resources associated with the GPU 150 and the CIP 160 to enable the management and allocation, in real-time, of the visual assets 110 and 120, and the connectivity interface assets 170 of exemplary wearable display device 100.

FIG. 3 is a block diagram that illustrates the functional aspects of the vuOS 300. As illustrated in FIG. 3, the vuOS 300 is responsible for the allocation of the wearable display device 100 multiple segments or slots or zones of the visual access FOV 180 (i.e., gaze zone 240 and peripheral visual, or extended gaze, zones 245), while GPU 150 is responsible for implementing the allocation of the multiple segments of the visual access FOV 180 as determined by the vuOS 300. Similarly, illustrated in FIG. 3 the vuOS 300 is also responsible for the allocation of the multiple connectivity interfaces 170 of the wearable display device 100, while CIP 160 is responsible for implementing the allocation of the multiple connectivity interfaces 170 to the multiple computing platforms connected to the wearable display device 100 as determined by the vuOS 300. The vuOS 300 is also responsible for decoding and implementing the user's visual access prompts and the visual access requests from the multiple computing platforms connected to the wearable display device 100.

The CIP 160 typically receives the user's visual access prompts from the one or more sensors 132 connected to it and sends these prompts to the GPU 150 which internally routes them to the visual access operating system (vuOS) 300. The CIP 160 also receives the visual access requests from the computing platforms connected to it and sends these visual access requests to the GPU 150 which internally routes the requests to the vuOS 300. The vuOS 300 in return allocates and sets up visual access slots or segments or zones, for example, gaze zone 240 and/or extended gaze zones 245, allocates corresponding necessary link connectivity access slots for the computing platforms assigned to the allocated visual access slots and thereafter maintains the assigned visual assets and connectivity interface assets in response to the user's (or viewer's) prompts. The vuOS 300 maintains the assigned visual access slots by commanding the GPU 150 to accordingly configure and maintain the visual assets 110 and 120. The vuOS 300 also maintains the link connectivity to the computing platform assigned to the visual access slot by commanding the CIP 160 to accordingly configure and maintain the interface between the wearable display device 100 and the computing platform assigned to the visual access slot.

Being the operational manager of the viewer's visual access to the multiple computing platforms connected to the wearable display device 100, the visual access operating system vuOS 300 is the highest tier operating system within the mobile user computing environment in that it is responsible for managing access to the visual resources that interface the user to the multiple computing platforms connected to the wearable display device 100. The visual access operating system vuOS 300 interfaces with possibly a set of different operating systems that manage the respective resources of the multiple computing platforms connected to the wearable display device 100. For example, the connected Smartphone operating system could be either iOS or Android, while the connected PC operating system could be Microsoft MS-10, and the connected car multimedia computer operating system could be yet another different operating system. Such a set of different operating systems that manage the resources of the multiple computing platforms may be connected to the wearable display device 100 interface with the visual access operating system vuOS 300 using an application programming interface (API) module (not shown) that defines all possible modes of interactions, and the related control, data, and interface protocols with the visual access operating system vuOS 300. Among such interactions is handling the responses to the user's prompts and the visual access requests from the multiple computing platforms connected to the wearable display device 100 described earlier. The visual access operating system vuOS 300 API module encapsulates the visual access operating system vuOS 300 interface protocols and is designed to be compatible with all possible (nominal) set of different operating systems that manage the resources of the multiple computing platforms connected to the wearable display device 100.

Referring to FIG. 3, the visual access operating system vuOS 300 is depicted as being responsible for the visual context switching that enables visual access to the multiple computing platforms assigned to gaze zone 240 and peripheral visual zones 245 of the user's visual access field of view (FOV) 180 while also being logically connected to the multi-link interface controller 190, which is a software module that executes on the CIP 160 and is responsible for the allocation of the wearable display device 100 connectivity interface resources which could include multiple wireless physical links (or channels) each of which may be partitioned into multiple time division interface access slots, as well as at least one wired link that could be used concurrently with the multiple wireless links. The multi-link interface controller 190 processes the interface access commands generated by the visual access operating system vuOS 300 to enable commensurate connectivity interface access resources to the set of computing platforms assigned visual access by the visual access operating system vuOS 300. Herein the assigned visual access and its corresponding multi-link interface access will be referred to as “visual access” and “interface access” slots, respectively. The following discussion provides details of the interaction protocols that enable the visual access operating system vuOS 300 to assign (allocate) visual access, and interface access, slots and to perform the visual context switching involving these assigned resources.

Visual access slots are allocated by the visual access operating system vuOS 300 to one of gaze zone 240 and extended gaze zones 245, according to embodiments of the invention. Recall from the above discussion that the optical elements 120L and 120R define the geometric extent of the user's visual access Field of View (FOV) 180 of the exemplary wearable display device 100. However, the visual access slots allocated by the visual access operating system vuOS 300 need not span the full geometric extent in the vertical, and/or horizontal, directions of the FOV of the wearable display device 100.

The visual access operating system vuOS 300 is capable of allocating split FOV visual access slots, e.g., vertical FOV visual access slots, and is also capable of allocating the computing resources of GPU 150 needed to decode and scale the visual information to be displayed in such split FOV visual access slots. While the following discussion contemplates split vertical FOV visual access slots, it is appreciated that the discussion is also applicable to spit horizontal FOV visual access slots, or some combination of split vertical and horizontal FOV visual access slots, or some other arrangement of multiple FOV visual access slots, for example, concentric arc, or concentric circle, or tiled, FOV visual access slots.

FIG. 4 illustrates the visual access zones 240 and 245 of the wearable display device 100 that are being managed by the visual access operating system vuOS 300 and allocated one or more of multiple time division interface access slots amongst the multiple computing platforms connected with the wearable display device 100, according to embodiments of the invention. As illustrated in FIG. 4 a lower segment of the vertical visual access zones in FOV 180 includes an attention request zone 410 that spans across the lower horizontal FOV but only a small percentage, typically in the range of 10%, of the vertical FOV. Visually, one or more attention request icons 420 are overlaid as augmentation of the full visual access slots or visual display zones 240 and 245 within the attention request zone 410. In particular, the attention request zone 410 is overlaid by the visual operating system 300 on top of the full visual access slots 240 and 245. The attention request icons, which are augmentations included in the attention request zone 410, are allocated to actively connected computing platforms.

Visual access to the attention request icons 420 is allocated by the visual access operating system vuOS 300 to enable the multiple computing platforms connected to the wearable display device 100 to initiate visual access requests, for example, to request an expanded visual access slot. The term expanded visual access slot is meant to indicate the allocation of the gaze zone 240 and one or more of the peripheral extended gaze zones 245 to the same computing platform. The visual access operating system vuOS 300 commands the GPU 150 to augment the gaze zone 240 and possibly the peripheral visual access zones 245 display contents with visual access slots for displaying attention request icons 420. In other words, the attention request zone 410, where the attention request icons 420 are allocated, could extend across the lower portion of all three visual access zones 240 and 245, as illustrated in FIG. 4. Such attention request icons 420 may be assigned to a computing platform and/or may be assigned to an application (App) executing on one of the multiple computing platforms connected to the wearable display device 100.

In the case when the attention request icon 420 is assigned to a computing platform, it is used to submit a visual access slot request for that computing platform. In the case when an attention request icon 420 is assigned to an App executing on one of the computing platforms, it is used to submit a visual access slot request specifically for the App executing on that computing platform. In the latter case the visual access slot allocated in response by the vuOS 300 need not be a full FOV visual access slot and may be limited to a visual access window 440 that overlaps a portion of the full FOV visual access slot as an augmentation. Herein above such visual access windows 440 are referred to as augmented visual access slots since such visual access slots would be an overlay or an augmentation of a full FOV visual access slot 240 or 245 in which the visual information being displayed could be from an App executing on the same computing platform to which the full visual access slot is assigned or from an App executing on a different one of the computing platforms connected to the wearable display device 100.

A computing platform becomes “actively connected” once it has successfully paired with the wearable display device 100 and acquired an attention request icon 420. This is, in effect, a log-on or log-in procedure that allows computing platforms to establish connection with the wearable display device 100 and thereafter be able to expand their visual access slot assignment by signaling their requests in the allocated attention request icon 420.

Referring to FIG. 4, when a connected computing platform or an App within a connected platform requests a visual access slot, the visual access operating system vuOS 300 illuminates the associated attention request icon 430, possibly intermittently, to signal the computing platform request for visual access to the user of the wearable display device 100. The vuOS 300 processes the visual access slot request signaled by the illuminated attention request icon when the user either focuses on the illuminated attention request icon or points a gesture cursor at the illuminated attention request icon 430. It is also possible for the vuOS 300 to process the visual access slot request signaled by the illuminated attention request icon 430 based on a user's voice command, or other forms of user input. When the visual access slot request signaled by the illuminated attention request icon 430 is confirmed, the visual access operating system vuOS 300 allocates a visual access slot to the requesting computing platform or the requesting App within the computing platform. The visual access slot allocated by the vuOS 300 in response to the illuminated attention request icon 430 is in accordance with a set of visual access parameters associated with the attention request icon 420 that are defined and set up at initialization by the user of the wearable display device 100, according to one embodiment of the invention.

The wearable display device 100 icons 420, 430 and augmented visual access slots 440 are allocated by the vuOS 300 to the connected computing platforms which can be in either active or standby mode. When visual access slots are allocated to a computing platform in the active mode, the allocated visual access slots may be within the wearable display device 100 user's gaze zone 240, the extended gaze zones (peripheral vision zones) 245 or in the attention request icons 420 or augmented visual access slots 440. In other words, the allocated visual access slot could be: (1) the gaze zone 240; (2) one of the extended gaze zones 245; (3) the attention request icon 420; (4) the illuminated attention icon 430; or (5) the augmented visual access slot 440 which is overlaid anywhere within the visual access zones 240 and 245. An actively connected computing platform can use its attention request icon 420 to signal the request for an augmented visual access slot 440 on behalf of one of it Apps that, for example, may intermittently require visual access. For example a text messaging, chat, or social media App on the phone needing to display a message or post it just received. It is also possible that the visual access slot allocated to one connected computing platform extends across multiple visual access slots, that is, a visual access slot may comprise multiple visual access slots. For example, the visual access slot allocated to one computing platform could extend across the combined visual access region of the gaze zone 240 and one or more of the extended gaze zones 245. In another example the gaze zone 240 is allocated to one computing platform while an attention request icon 420 is allocated to an App executing on that specific computing platform. In a third example, the gaze zone 240 and the extended gaze zone 245 are each allocated to different computing platforms and an augmented visual access slot 440 is allocated within the gaze zone 240 or the extended gaze zones 245 to a different computing platform.

When a connected computing platform is in the standby mode, an attention request slot or icon 420 is allocated by the vuOS 300 to that connected computing platform. In such case the connected computing platform uses the allocated attention request icon 420 to signal requests generated by its own operating system or App executing thereon for one or more visual access slots within the wearable display device 100 user's gaze zone 240, the extended gaze zones 245 or an augmented visual access slot 420, that is, case (5) of the above response in which the operating system of a connected platform generates an attention request on behalf of an App running on that computing platform.

The vuOS 300 API executing as a software component on each of the connected computing platforms is responsible for performing the visual access protocol described in the previous paragraphs based on requests initiated by the computing platform operating system. The vuOS 300 API is downloadable onto the candidate computing platforms over a suitable communications link, such as the Internet or the web in order to enable connectivity to the wearable display device 100.

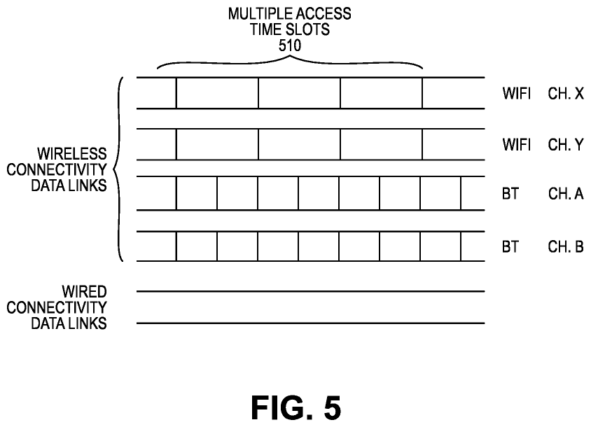

FIG. 5 illustrates the wearable display device 100 physical interfaces that are being managed and allocated by the visual access operating system vuOS 300 amongst the multiple computing platforms connected with the wearable display device 100. As stated earlier, the wearable display device 100 may be connected to multiple computing platforms using multiple connectivity links. Several of such connectivity links may be wireless interfaces, such as WiFi and Bluetooth (BT), and at least one such connectivity may use a wired interface physically connected to the wearable display device 100, for example, a USB interface. As illustrated in FIG. 5, the wearable display device 100 connectivity interface assets may comprise multiple wireless frequency channels that are each partitioned into time division access slots 510. Furthermore, the wireless connectivity interface assets may be either high bandwidth, such as WiFi, or low bandwidth, such as Bluetooth (BT). The connectivity throughput of these multiple wireless interface links may be allocated to the connected multiple computing platforms as time division access slots 510. In either case, the connectivity throughput of the link allocated to any given computing platform is commensurate with the data rate requirements of their allocated visual access slots 240, 245, icons 420, 430, or augmented visual access slots 440. The connectivity throughput allocation is determined by the vuOS 300 and relayed through the GPU 150 to the CIP 160, which controls the multiple link connectivity. For example when the visual access slot 240 is allocated for a given computing platform, the vuOS also allocates wireless or wired time division access slots with sufficient data rate to support visual data display in the allocated visual access slot 240. Similarly when the augmented visual access slot 440 is allocated to a given computing platform, the visual operating system will allocate a wireless time division access slot with a lower data rate to support the typically more limited visual data display in the allocated augmented visual access slot 440.

Allocation of the connectivity throughput needed to service an augmented visual access slot 440 allocated to a given computing platform is typically much smaller than what is required to service a gaze zone 240 or one or more extended gaze zones 245 visual access slot allocation. Allocation of the connectivity throughput to service an attention request icon 420 or illuminated request icon 430 is even smaller than the connectivity throughput needed to service an augmented visual access slot 442. For these smaller connectivity throughput requirements the vuOS 300 allocates either an intermittent wireless time division access slot or possibly even a time division connectivity access on a lower data rate wireless link, such as BT wireless link, for example.

The visual access slots allocated by the visual access operating system vuOS 300 may extend across the user's FOV depth when the wearable display device 100 supports light field modulation capabilities and the visual information data that is provided to the wearable display device 100 is also across a viewable light field. For reference a viewable light provides the viewer with depth focusable visual information FOV that resembles the natural way of seeing the visual information the viewer is typically accustomed to seeing in daily activities. In this case the visual access slots allocated by the vuOS 300 extend along the viewing depth axis of the wearable display device 100 visual FOV 180 and are selected by the viewer's focus depth action, also known as vergence accommodation. In this case the differentiation by the wearable display device 100 user between the allocated number of augmented visual access slots 440 occurs by the focused details of the viewer's accommodated augmented visual access slots 440 versus the blurred appearance of out-of-focus augmented visual access slots 440. In this case the vuOS 300 is able to coordinate the allocation of visual access slots and perform the associated visual context switching of multiple correlated visual contents from the set of the different connected computing platforms. For example this capability enables the wearable display device 100 to display visual content captured at different depths in the same environment but provided to the wearable display device 100 by the set of the different connected computed computing platforms.

The wearable display device 100 can include memory. In various examples, the memory can include system memory, which may be volatile (such as RAM), non-volatile (such as ROM, flash memory, non-volatile memory express (NVMe), etc.) or some combination of the two. The memory can further include non-transitory computer-readable media, such as volatile and nonvolatile, removable and non-removable media implemented in any method or technology for storage of information, such as computer readable instructions, data structures, program modules, or other data. System memory, removable storage, and non-removable storage are all examples of non-transitory computer-readable media. Examples of non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other non-transitory medium which can be used to store desired information and which can be accessed by the wearable display device 100. Any such non-transitory computer-readable media may be part of the wearable display device 100.

The memory can store data associated with the CIP 160, the GPU 150, the vuOS 300, and/or any other element of the wearable display device 100. The memory can also store other modules and data. The modules and data can include any other modules and/or data that can be utilized by the wearable display device 100 to perform or enable performing the actions described herein. Such other modules and data can include a platform, operating system, and applications, and data utilized by the platform, operating system, and applications.

By way of a non-limiting example, the wearable display device 100 may have non-volatile memory, such as an NVMe disk, and may also have volatile memory, such as synchronous dynamic RAM (SDRAM), double data rate (DDR) SDRAM, DDR2 SDRAM, DDR3 SDRAM, or DD4 SDRAM.

The wearable display device 100 can also have one or more processors. In various examples, each of the processors can be a central processing unit (CPU), a graphics processing unit (GPU), both a CPU and a GPU, or any other type of processing unit. Each of the one or more processors may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processors may also be responsible for executing computer applications stored in the memory, which can be associated with types of volatile and/or nonvolatile memory.

Those skilled in the art will readily appreciate that various modifications and changes can be applied to the embodiments of the invention without departing from its scope defined in and by the appended claims. It should be appreciated that the foregoing examples of the invention are illustrative only, and that the invention can be embodied in other specific forms without departing from the spirit or essential characteristics thereof. The disclosed embodiments, therefore, should not be considered to be restrictive in any sense. The scope of the invention is indicated by the appended claims, rather than the preceding description, and all variations which fall within the meaning and range of equivalents thereof are intended to be embraced therein.

What is claimed:

1. A wearable display system for a user, comprising:
an optical element that provides a visual access field of view for the user;
a display element optically coupled with the optical lens element;
a processing unit coupled to the display element;
a plurality of connectivity interfaces to connect to a plurality of external computing platforms;
a connectivity interface processor coupled to the processing unit and to the plurality of connectivity interfaces to control the plurality of connectivity interfaces to connect to the plurality of external computing platforms;
a sensor that detects selected movements of the user; and
a software module executing on the processing unit to provide visual access to at least a portion of the optical element-provided visual access field of view for at least one of the plurality of external computing platforms responsive to the sensor detecting at least one of the selected movements of the user.

2. The wearable display system of claim 1, wherein the software module executing on the processing unit to provide visual access to the at least a portion of the optical element-provided visual access field of view for one of the plurality of external computing platforms comprises the software module executing on the processing unit to provide visual access to the at least a portion of the optical element-provided visual access field of view for the first one of the plurality of external computing platforms by assigning a first visual access slot or zone within the optical element-provided visual access field of view for the user to the first one of the plurality of external computing platforms.

3. The wearable display system of claim 2, wherein the software module executing on the processing unit to further provide visual access to the at least a portion of the optical element-provided visual access field of view for a second one of the plurality of external computing platforms by assigning a second visual access slot or zone within the optical element-provided visual access field of view for the user to the second one of the plurality of external computing platforms.

4. The wearable display system of claim 3, further comprising the software module executing on the processing unit to switch providing visual access to the first one of the plurality of external computing platforms by assigning the first visual access slot or zone within the optical element-provided visual access field of view for the user to the second one of the plurality of external computing platforms and switch providing visual access to the second one of the plurality of external computing platforms by assigning the second visual access slot or zone within the optical element-provided visual access field of view for the user to the first one of the plurality of external computing platforms, responsive to the sensor detecting at least one of the selected movements of the user.

5. The wearable display system of claim 4, wherein the selected movements of the user are selected from a group of movements of the user consisting of: a head movement, a hand gesture, a finger gesture, an eye movement or eye focus direction (visual command), and a voice command.

6. The wearable display system of claim 2, wherein the software module executing on the processing unit to provide visual access to the at least a portion of the optical element-provided visual access field of view for a second one of the plurality of external computing platforms by assigning a second visual access slot or zone outside the optical element-provided visual access field of view for the user to the second one of the plurality of external computing platforms.

7. The wearable display system of claim 6, wherein the software module executing on the processing unit to switch visual access to the first one of the plurality of external computing platforms by assigning the first visual access slot or zone within the optical element-provided visual access field of view for the user to the second one of the plurality of external computing platforms and switch visual access to the second one of the plurality of external computing platforms by assigning the second visual access slot or zone outside the optical element-provided visual access field of view for the user to the first one of the plurality of external computing platforms, responsive to the sensor detecting at least one of the selected movements of the user.

8. The wearable display system of claim 2, wherein the software module executing on the processing unit to provide visual access to the at least a portion of the optical element-provided visual access field of view for the first one of the plurality of external computing platforms by assigning the first visual access slot or zone within the optical element-provided visual access field of view for the user to the first one of the plurality of external computing platforms is further to allocate one or more of the connectivity interfaces to the first one of the plurality of external computing platforms by commanding the connectivity interface processor coupled to the processing unit and to the plurality of connectivity interfaces to control the plurality of connectivity interfaces to connect to the first one of the plurality of external computing platforms.

9. The wearable display system of claim 1, wherein the software module executing on the processing unit to provide visual access to the at least a portion of the optical element-provided visual access field of view for the at least a portion of the optical element-provided visual access field of view for one of the plurality of external computing platforms responsive to a request from one of the plurality of external computing platforms or application program executing thereon.
